(19) United States
(12) Patent Application Publication
(10) Pub. No.: US 2013/0016616 A1
(43) Pub. Date: Jan. 17, 2013

(54) METHOD FOR BACKHAUL LINK PROTECTION IN A MIMO WIRELESS LINK

(71) Applicants: Mikael Coldrey, Landvetter (SE); Jonas Hansryd, Goteborg (SE)

(72) Inventors: Mikael Coldrey, Landvetter (SE); Jonas Hansryd, Goteborg (SE)

(73) Assignee: Telefonaktiebolaget L M Ericsson (publ), Stockholm (SE)

(21) Appl. No.: 13/637,346

(22) PCT Filed: Mar. 25, 2010
(86) PCT No.: PCT/EP2010/053920

§ 371 Date: Sep. 25, 2012

(51) Int. Cl. H04B 7/04; H04B 17/00

(52) U.S. Cl. 370/242

(57) ABSTRACT

A wireless communication link arrangement and a method performed in the communication link, which link comprises a first node with a plurality of transmitting antenna arrangements and a second node with a plurality of receiving antenna arrangements that forms a number of radio chains RC, each arranged to operatively communicate a signal a comprising a data stream so as to form a primary MIMO-scheme. At least one of the nodes is arranged to control the degradation of the link by being configured to operatively: detect a malfunction for at least one radio chain RC of the primary MIMO-scheme, select a communication scheme using a reduced number of data streams communicated by the other radio chains of the link arrangement, communicate the selection of the communication scheme to the other node, and continue the communication according to a communication scheme.

### TECHNICAL FIELD

The present invention relates to communication via wireless communication links e.g. backhaul links, and particularly to a controlled degradation in case of a malfunction occurring in such communication links.

### BACKGROUND

Wireless communication links are well known and widely used in connection with backhaul communication. Here, the expression “backhaul communication” is used for the communication between a core network or similar (e.g. such as the Evolved Packet Core (EPC) in the Long Term Evolution (LTE)) and one or several radio access nodes or similar (e.g. one or several base stations or similar) in a wireless communication network, and/or the communication that occurs between one or several radio access nodes and an access node controller or similar (e.g. a Base Station Controller (BSC) or a Radio Network Controller (RNC)) in a wireless communication network, and/or between an access node controller and the core network or similar.

To this end a known wireless communication link 100a is schematically illustrated in FIG. 1. It is preferred that the link 100a is a Line of Sight (LOS) wireless communication link. It is also preferred that the link 100a is fixed, i.e. the emitting and receiving parts of the link 1008 are preferably fixed and aligned with respect to each other and can therefore not be operationally moved or transported from one position to another. Here, Line of Sight (LOS) refers to electromagnetic radiation wave propagation including light emissions travelling in a straight line. Typically. LOS links use highly directional antennas arranged such that the antenna lobe of a first antenna (e.g. Tx1) points at a second antenna (e.g. Rx2) and such the antenna lobe of the second antenna (e.g. Rx2) points at the first antenna (e.g. Tx1). The lobe of the antennas (e.g. Tx1, Rx1) may e.g. extend less than 10°, or less than 5°, or less than 3° in the vertical and the horizontal direction or at least in the horizontal direction. The concept of LOS may be thought of as the ability of the human eye to visually see a transmitting antenna, which roughly corresponds to the ability to receive a transmission (e.g. by means of light emission) from the antenna in question. Reflections or similar are typically avoided and/or suppressed with respect to known fixed LOS links, e.g. due to the narrow antenna lobes used in this connection. However, there may nevertheless be reflections that has to be handled by the link, e.g. in case of link communication occurring partly or fully over a water surface (e.g. such as a lake or similar) or link communication in a desert area wherein air layers of different temperature and/or density occur.

As can be seen in FIG. 1 the known link 100a comprises a first node N1 with a first antenna Tx1 and a second node N2 with a second antenna Rx1. The nodes N1, N2 and the antennas Tx1. Rx1 respectively are arranged to operatively communicate information via a wireless transmission path 130a. The nodes N1, N2 and the antennas Tx1, Rx1 may be arranged to communicate information via the transmission path 130a in one direction only (unidirectional), or in both directions (bidirectional) as illustrated by the two arrow heads in FIG. 1. The information may e.g. communicated via the transmission path 130a by means of a microwave signal, e.g. utilizing microwaves above 1 GHz, or above 6 GHz or above 30 GHz, or above 50 GHz including various forms of light.

A drawback associated with the known link 100a is that a malfunction in either node N1, N2 may cause a complete shutdown of the link. Generally, this is not acceptable in commercial applications. For example, microwave links that are used for backhaul communication in wireless mobile communication systems are required to function substantially without any downtime. The link functionality must often be guaranteed close to 100% of the time (99.99 or 99.999% availability a common availability grades). This means that wireless links for backhaul communication should be more robust against hardware and software failures than link 100a.

To this end FIG. 2 shows a known 1+1 wireless communication link arrangement 200 that is more robust to hardware and software failures. The link arrangement 200 comprises a primary link 100a as described above with reference to FIG. 1 and an additional secondary wireless link 100b. It is preferred that the secondary link 100b is substantially identical to the primary link 100a. Both links 100a, 100b are typically a part of the first and second node N1, N2 respectively. Thus, the first node N1 may have a first antenna Tx1 and a second antenna Tx2, whereas the second node N2 may have a first antenna Rx1 and a second antenna Rx2. In the link 200 the nodes N1, N2 and the antennas Tx1, Rx1 are arranged so as to operatively communicate information via a primary wireless transmission path 130a, whereas the nodes N1, N2 and the antennas Tx2, Rx2 are arranged to operatively communicate information via a secondary wireless backup transmission path 130b. The secondary transmission path 130b may be identical or substantially identical to the primary transmission path 130a.

In normal operation the link arrangement 200 uses the primary link 100a. In case of a malfunction at either node N1 or N2 affecting the communication via the primary link 100a the link arrangement 200 can continue the operation by switching the communication to the secondary link 100b. Thus a malfunction will rarely cause a shut down of the whole link arrangement 200.

A drawback associated with the known link arrangement 200 is that the secondary link 100b increases the cost of the link arrangement 200 while remaining substantially idle as a redundant backup resource most of the time.

A solution that mitigates these drawbacks is illustrated in FIG. 3a showing a known 2×2 wireless communication link arrangement 300. The link arrangement 300 comprises a first node N1 with a first antenna Tx1_P and a second antenna Tx2_Q, and a second node N2 with a first antenna Rx1_P and a second antenna Rx2_Q.

In the link arrangement 300 the nodes N1, N2 and the antennas Tx1_P, Rx1_P form a first link 100a′ arranged to operatively communicate information via a wireless transmission path 330a, whereas the nodes N1, N2 and the antennas Tx2_Q, Rx2_Q form a second link 100b′ arranged to operatively communicate information via a wireless transmission path 330b. The transmission paths 330a, 330b may be identical or substantially identical. In other embodiment they may differ from each other. The transmission paths 330a, 330b are preferably orthogonal with respect to each other as will be further elaborated below.

For the sake of simplicity we may assume that the transmission paths 330a, 330b communicate information in one direction only (unidirectional) as indicated in FIG. 3a. Thus, we assume that the antennas Tx1_P, Tx2_Q and node N1 are arranged to operatively transmit information via the transmission paths 330a, 330b respectively, whereas the antennas Rx1_P, Rx2_Q and node N2 are arranged to operatively receive information transmitted via the transmission paths 330a, 330b respectively. However, node N1, N2 and the antennas Tx1_P, Tx2_Q, Rx1_P, Rx2_Q may be arranged to operatively communicate information in both directions (bidirectional) via the transmission paths 330a, 330b.

The antennas Tx1_P, Rx1_P and the transmission path 330a may be identical or similar to the antennas Tx1, Rx1 and the transmission path 130a respectively of the communication link 100a in FIG. 1. Similarly, the antennas Tx2_Q, Rx2_Q and the transmission path 330b may also be identical or similar to antennas Tx1. Rx1 and the transmission path 130a of the communication link 100a in FIG. 1. In other words, as already indicated the antennas Tx1_P, Rx1_P and the transmission path 330a may form a first wireless link 100a′, whereas the antennas Tx2_Q, Rx2_Q and the transmission path 330b may form a second similar or substantially identical wireless link 100b′.

However, it is preferred that the information transmitted via the transmission path 330a is substantially orthogonal with respect to the information transmitted via the transmission path 330b. This means that the information transmitted via the transmission path 330a will neither create nor propagate side-effects that affect the information transmitted via the transmission path 330b. Conversely, the information transmitted via the transmission path 330b will neither create nor propagate side-effects that affect the information transmitted via the transmission path 330a. Expressed in another way, the receiver of N2 receiving the information transmitted via the transmission path 330a can completely or almost completely reject the information transmitted via the transmission path 330b. Similarly, the receiver of N2 receiving the information transmitted via the transmission path 330b can completely or almost completely reject the information transmitted via the transmission path 330a.

A well known manner of providing such orthogonality is to use Polarisation Multiplexing (PM) according to which separate antennas with different polarization are used for the transmission paths 330a, 330b. For example, antennas Tx1_P and Rx1_P may be arranged to communicate information via transmission path 330a according to a first antenna polarization (P), whereas antennas Tx2_Q, Rx2_Q may be arranged to communicate information via transmission path 330b according to a second different antenna polarization (Q). The antenna polarization may e.g. be horizontal-vertical polarization or slanted polarization (e.g.)+/−45° or left-right circular polarization or similar. It should be emphasised that PDA is merely an example of providing communication by means of signals that are orthogonal at the same frequency at the same time.

As already indicated, in normal operation the known link 300 communicates information via the two transmission paths 330a, 330b. A malfunction at either node N1, N2 affecting one of the transmission paths 330a, 330b causes the link 300 to fall back to communicate via the remaining transmission path. For example, a malfunction in the transmitting antenna Tx1_P or the receiving antenna Rx1_P terminating the transmission path 330a will cause the link 300 to fall back to communicate via the remaining transmission path Rx1_P as illustrated in FIG. 3b.

The link arrangement 300 has an advantage over the link arrangement 200 in that the link arrangement 300 does not have any unused backup parts that are left idle during normal operation. Instead, the simultaneous use of a first link formed by antennas Tx1_P, Rx1_P and a second link formed by the antennas Tx2_Q, Rx2_Q provides an increased communication capacity.

However, the known link 300 has a drawback in that a malfunction at either node N1, N2 terminating one of the transmission paths 330a, 330b causes a capacity reduction of substantially 50%. This is still unsatisfactory, considering that a backhaul link should generally be operational close to 100% of the time. This requirement is emphasised as the demand on backhaul wireless communication links rises, e.g. due to the more effective base stations in the Long Term Evolution (LTE) defined within the framework of the 3^{rd} Generation Partnership Project (3GPP, see e.g. www.3gpp.org) requiring backhaul communication with Gigabit capacity or more between the radio access node(s) (i.e. a base station such as the NodeB or the eNodeB) and a core network and/or a core network node.

Thus, there seems to be a need for a wireless communication link arrangement that provides an increased capacity, particularly in case of a malfunction.

### SUMMARY OF THE INVENTION

The present invention provides a solution that eliminates or reduces at least one of the disadvantages discussed in the background section above. Hence, the present invention provides at least one improvement with respect to the discussion above, which improvement is accomplished according to a first embodiment of the invention directed to a method for a controlled degradation in a wireless communication link arrangement. The communication link comprises a first node with a plurality of transmitting antenna arrangements and a second node with a plurality of receiving antenna arrangements, which together forms a number of radio chains. Each radio chain is configured to operatively communicate a signal comprising a data stream so as to form a primary MIMO-scheme.

The method is preformed in at least one of the first node and/or the second node and it comprises the steps of: detecting a malfunction for at least one radio chain of the primary MIMO-scheme; selecting a secondary communication scheme using a reduced number of data streams communicated by the other radio chains of the link arrangement; communicating the selection of the secondary communication scheme to the other node, and continuing the communication according to a secondary communication scheme.

In a further embodiment it is preferred that the communication scheme of the first embodiment is at least partly provided according to at least one of: a spatial multiplexing scheme for obtaining a high communication capacity; or an antenna diversity scheme for obtaining a high communication reliability or a high communication capacity; or a beam forming scheme for increasing the power of signals transmitted by the communication scheme.

In another embodiment comprising the features of the further embodiment it is preferred that the spatial multiplexing scheme is a secondary MIMO scheme, whereas the antenna diversity scheme and the beam forming scheme is one of: a secondary MIMO scheme, a MISO scheme or a SIMO scheme.

In still another embodiment, comprising the features of any one of the preceding embodiments, it is preferred that the wireless communication link arrangement is a Point to Point link or Point to Multipont link being arranged as a fixed link and/or a Line of Sight link.

In an even further embodiment, comprising the features of any one of the preceding embodiments, it is preferred that the wireless communication link arrangement provides backhaul communication in a wireless mobile communication system.

In addition, the present invention provides at least one improvement with respect to the discussion in the background above. The improvement is accomplished according to a second embodiment of the invention directed to a wireless communication link arrangement comprising a first node with a plurality of transmitting antenna arrangements and a second node with a plurality of receiving antenna arrangements that forms a number of radio chains each arranged to operatively communicate a signal comprising a data stream so as to form a primary MIMO-scheme. At least one of the first node and/or the second node is arranged to control the degradation of the link by being configured to operatively: detect a malfunction for at least one radio chain of the primary MIMO-scheme; select a secondary communication scheme using a reduced number of data streams communicated by the other radio chains of the link arrangement; communicate the selection of the secondary communication scheme to the other node; and continue the communication according to a secondary communication scheme.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasised that the steps of the methods defined in the appended claims may, without departing from the present invention, comprise additional steps and/or be performed in another order than the order in which they appear in the claims.

### BRIEF DESCRIPTION OF THE DRAWINGS

FIG. 1 is a schematic illustration of an exemplifying known wireless communication link 100a.

FIG. 2 is a schematic illustration of an exemplifying known 1+1 wireless communication link 200.

FIG. 3a is a schematic illustration of an exemplifying known 2×2 wireless communication link 300.

FIG. 3b is a schematic illustration of the link 300 when the communication provided by one antenna Rx1_P has malfunctioned.

FIG. 4a is a schematic illustration of an exemplifying wireless communication link arrangement 400a according to an embodiment of the present invention.

FIG. 4b is a schematic illustration of the link 400a when the communication provided by the transmitting antenna Tx1 has malfunctioned.

FIG. 4c is a schematic illustration of the link 400a when the communication provided by the receiving antenna Rx3 has malfunctioned.

FIG. 5a is a schematic illustration of an exemplifying wireless communication link arrangement 400b according to another embodiment of the present invention,

FIG. 5b is a schematic illustration of the link 400b when the communication provided by the transmitting antenna Tx2_Q has malfunctioned.

FIG. 5c is a schematic illustration of the link 400b when the communication provided by the receiving antenna Rx3_P has malfunctioned.

FIG. 6 is a schematic illustration of an exemplifying radio chain RC.

FIG. 7 is a schematic illustration of communication link 400a or 400b used for backhaul communication in a wireless communication system 900.

FIG. 8 is a flowchart illustrating the operation of an exemplifying embodiment of the present invention.

### DETAILED DESCRIPTION OF EMBODIMENTS

### Structure of Embodiments

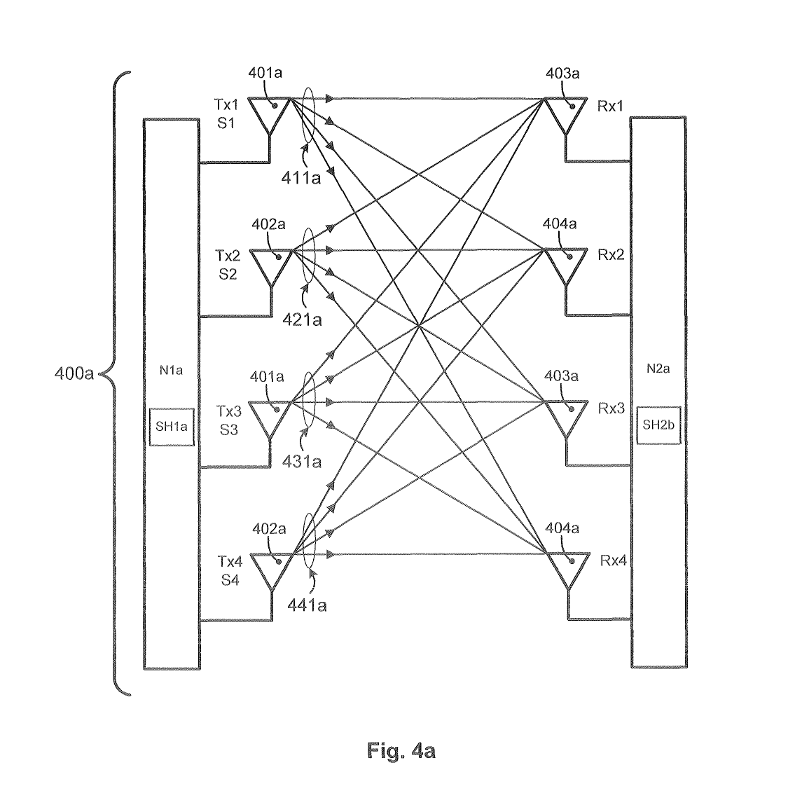

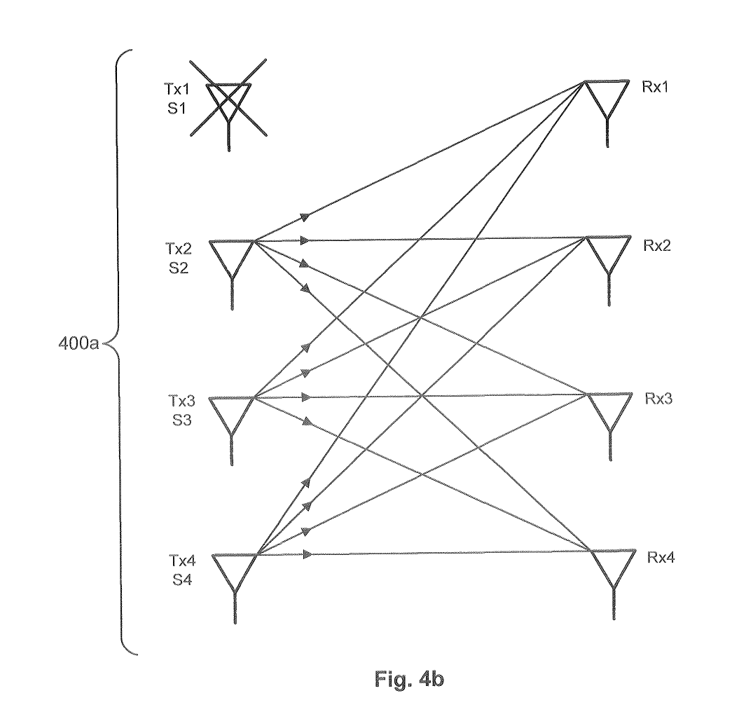

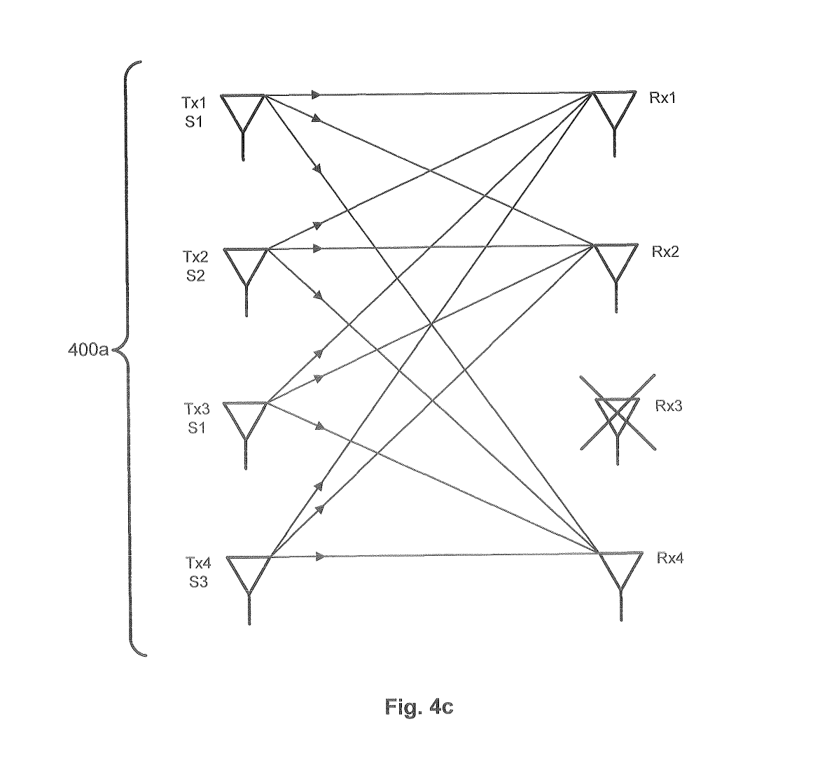

FIG. 4a is a schematic illustration of an exemplifying wireless communication link arrangement 400a according to an embodiment of the present invention. The link 400a provides an increased capacity compared to the links 100, 200 and 300 described above. The link 400a may be a Line of Sight (LOS) wireless communication link. In addition, or alternatively, the link 400a may be a fixed link, i.e. the emitting and receiving parts of the link 400a are preferably fixed and aligned with respect to each other and can therefore not be operationally moved or transported from one position to another.

The link arrangement 400a comprises a first node N1a and a second node N2a. The nodes N1a, N2a are typically separated by a physical distance of about 20-60 km, though they may be arranged at a much closer distance (e.g. less than 500 meters). This may e.g. be the case when the link 400a is used instead of wired communication (e.g. including copper and optical fibers etc), e.g. in cities where the wireless link hop may only extend from one building to another separated by a street or similar.

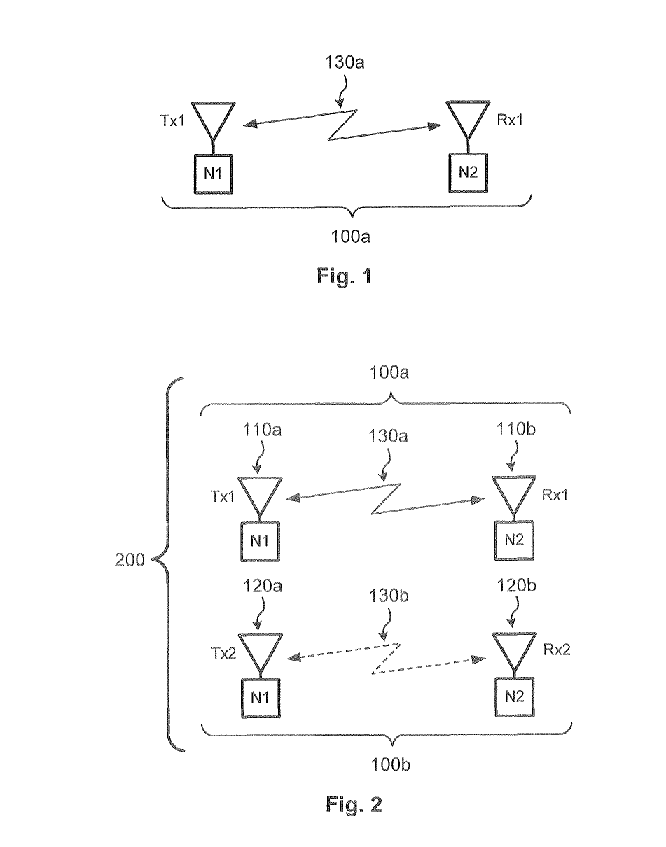

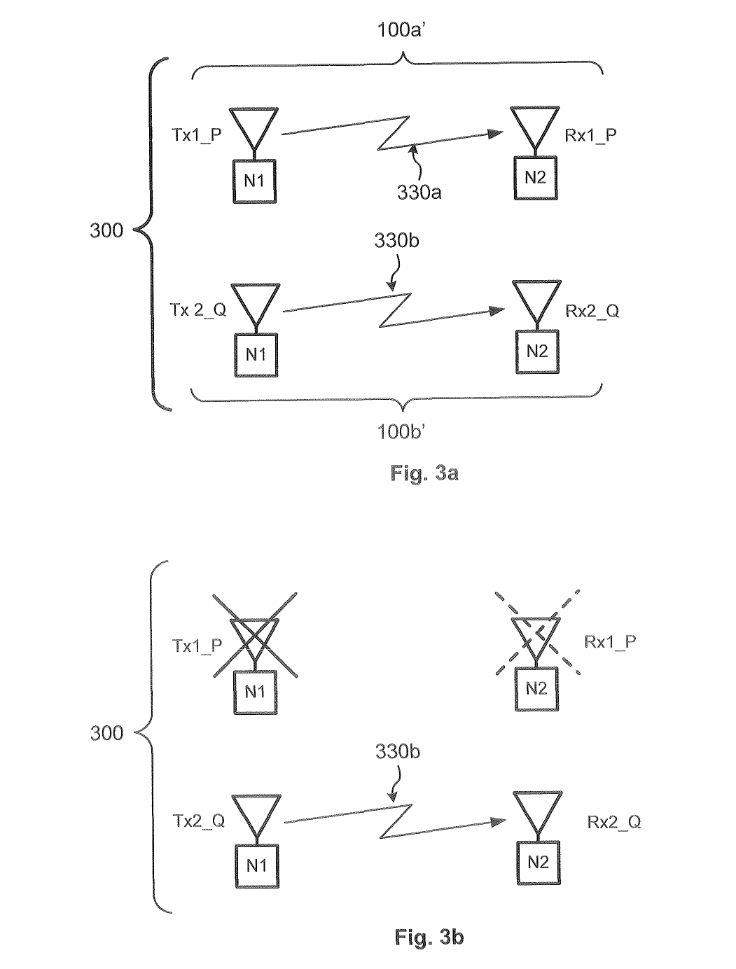

It is preferred that node N1a is provided with at least two (2) and preferably four (4) antenna arrangements Tx1, Tx2, Tx3, Tx4. It is also preferred that node N1a and its antenna arrangements is arranged to operatively communicate information with node N2a through wireless transmission paths indicated by arrows in FIG. 4a. Similarly it is preferred that node N2a has at least two (2) and preferably four (4) antenna arrangements Rx1, Rx2, Rx3, Rx4, and it is also preferred that node N2a is arranged to operatively communicate information with node N1a through said transmission paths. Preferably, the information transmitted from each antenna of the first node N1a is received by each antenna of the second node N2a via said transmission paths. The antenna arrangements Tx1, Tx2, Tx3, Tx4 and Rx1, Rx2, Rx3, Rx4 may e.g. be identical or similar to the antennas Tx1 and Rx1 respectively discussed above with respect to FIG. 1. Similarly, it is also preferred that the transmission paths now discussed are of the same or similar type as the transmission path 130a discussed with reference to FIG. 1, or as the transmission paths 330a, 330b discussed with reference to FIG. 3a. Thus, the wireless transmission paths in FIG. 4a may e.g. utilize microwaves above 1 GHz, or above 6 GHz or above 30 GHz, or above 50 GHz including various forms of light.

It should be emphasised that the 4×4 antenna constellation of link 400a is an example. Other antenna constellations are clearly conceivable. Embodiments of the invention may be implemented in substantially any antenna scheme using M×N antenna arrangements forming a symmetric antenna constellation (M=N) or an asymmetric antenna constellation (M≠N). Here it is assumed that both M and N corresponds to at least two (2) antenna arrangements.

The communication between the nodes N1a, N2a in link 400a may be bidirectional, though a unidirectional communication has been illustrated in FIG. 4a by means of arrows (transmission paths) extending from each antenna Tx1, Tx2, Tx3, Tx4 of node N1a to each antenna Rx1, Rx2, Rx3, Rx4 of node N2a.

To accomplish a unidirectional (or bidirectional) communication as indicated above it is preferred that node N1a comprises a first signal handling unit SH1a with hardware and/or software arranged to operatively communicate (i.e. transmit to and possibly receive from) information with node N2a via antennas Tx1, Tx2, Tx3, Tx4. Similarly it is preferred that node N2a comprises a second signal handling unit SH2a with hardware and/or software arranged to operatively communicate (i.e. receive from and possibly transmit to) information with node N1a via antennas Rx1, Rx2, Rx3, Rx4. It is also preferred that the signal handling units SH1a, SH2a are arranged to operatively accomplish the MIMO-schemes and the multiple antenna schemes of the embodiments discussed with reference to the link 400a.

It is also preferred that at least one or even both signal handling units SH1a, SH2a are arranged to operatively detect any malfunction in a radio chain arranged to operatively communicate a wireless signal 411a, 421a, 431a or 431a comprising a data stream S1, S2, S3 or S4 respectively as will be described later.

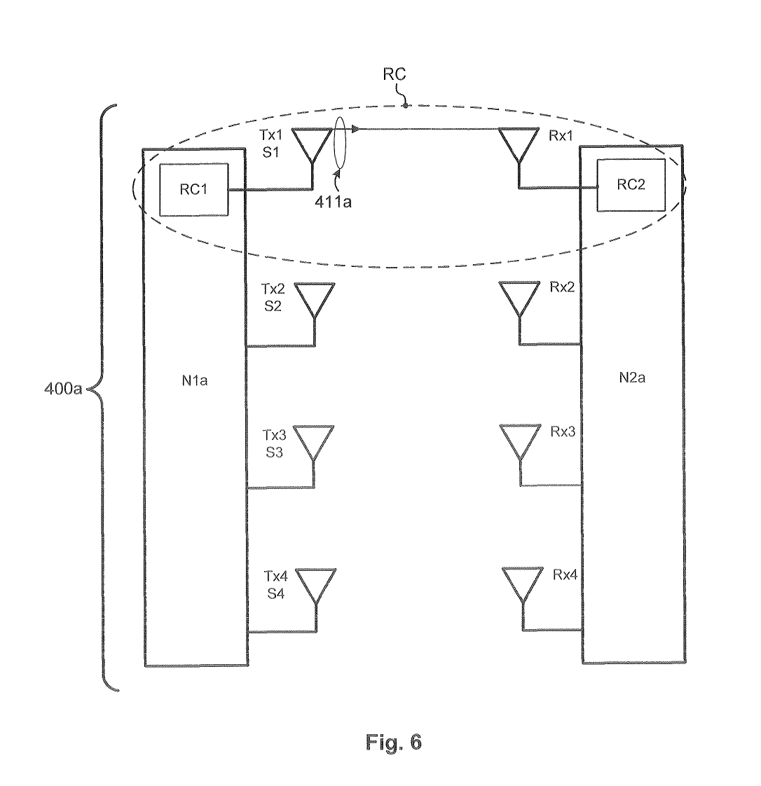

FIG. 6 is a schematic illustration of an exemplifying radio chain RC that communicates the signal 411a. As can be seen in FIG. 6 the radio chain RC comprises the antennas Tx1 and Rx1 of the link 400a. In addition to the antenna arrangements Tx1 and Rx1, the radio chain RC may e.g. comprise radio chain means RC1 in the first node SH1 and radio chain means RC2 in the second node, where each means may comprise analogue signal processing means and/or digital signal processing means and/or the transmitting amplifying means and/or the receiving amplifying means and/or other microwave components including microwave components for feeding the antenna arrangements Tx1 and Rx1 required for transmitting and receiving the wireless signal 411a in question.

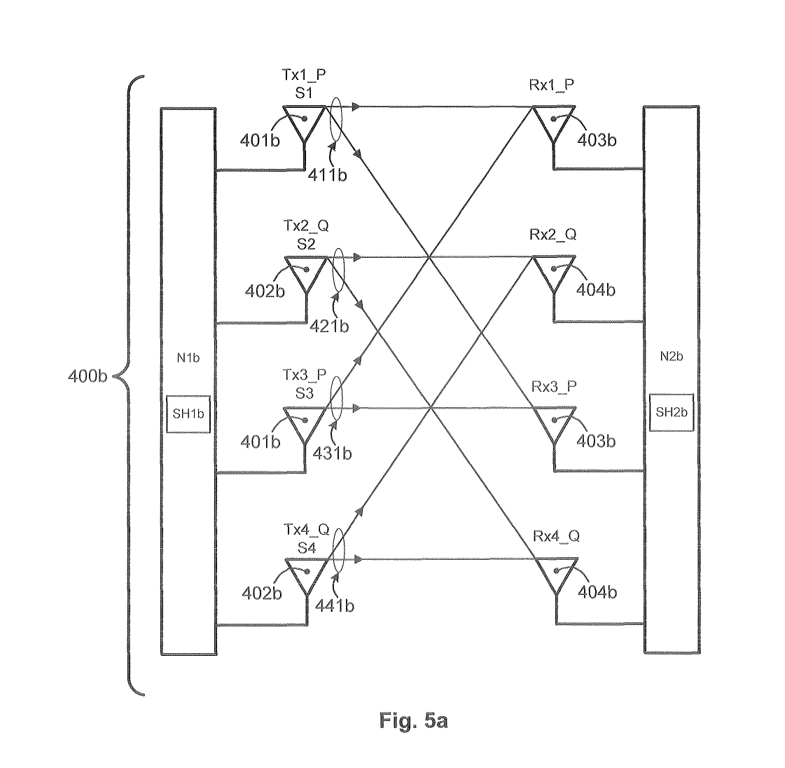

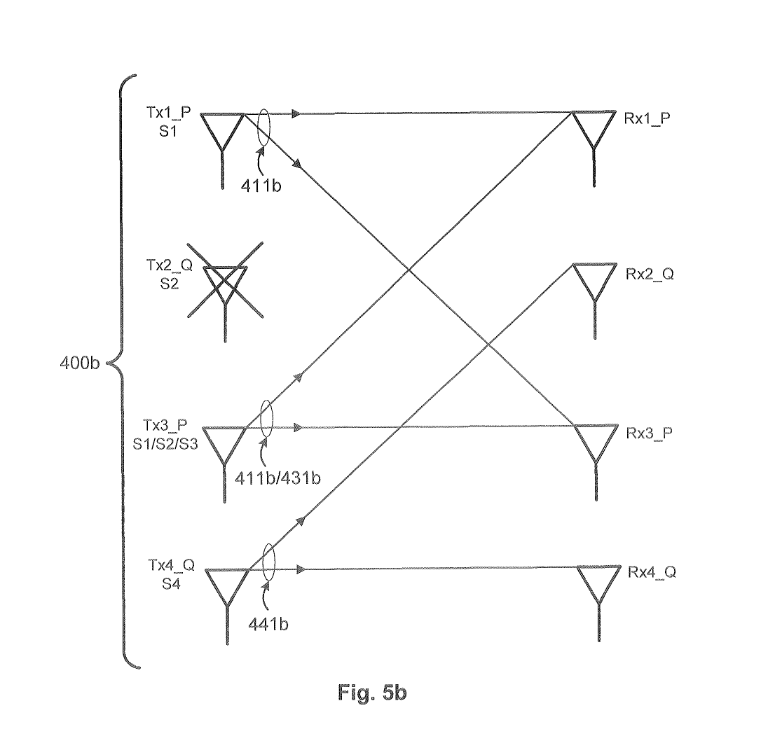

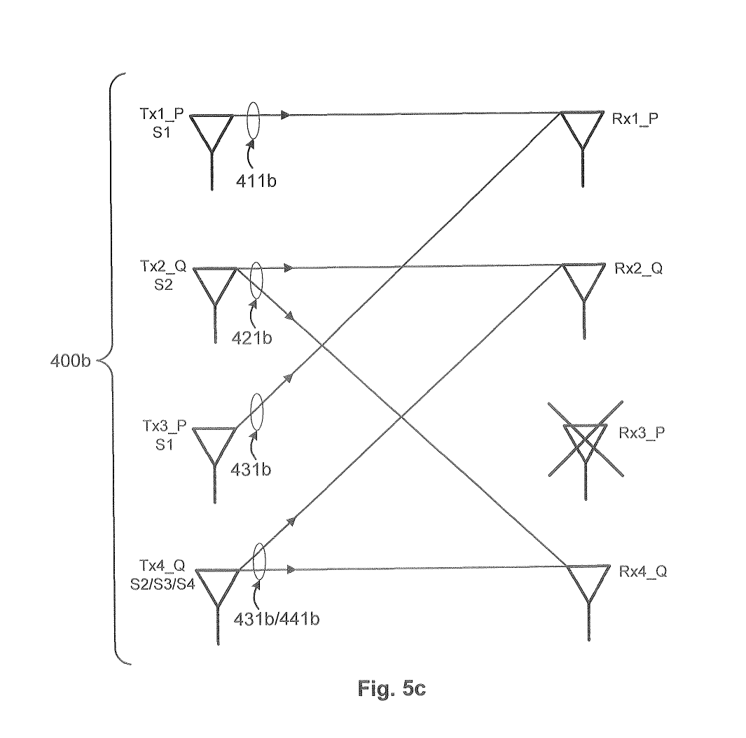

It should be emphasised that a radio chain of the same or similar type as the radio chain RC is formed for each communication path in the link 400a as indicated by arrows in FIG. 4a. The same applies mutatis mutandis for the communication paths in the link 400b indicated by arrows in FIG. 5a.

Thus, it should be clarified that a data stream, e.g. such as data stream S1 in FIG. 4a and FIG. 6, may e.g. be transmitted by a signal from one antenna, e.g. signal 411a from antenna Tx1 and the associated radio chain means RC1 in FIG. 6. The signal carrying the data stream may then be received by one or several antennas, e.g. Rx1, Rx2, Rx3, Rx4 as shown in FIG. 4a, each having an associated radio chain means, e.g. in the similar manner as antenna Rx1 and the associated radio chain means RC2. As explained above, Tx1 and Rx1 with their associated radio chain means RC1, RC2 form a first radio chain RC. In the same way, Tx1 and Rx2 with their associated radio means (radio means for Rx2 not shown) form a second radio chain, whereas Tx1 and Rx3 with their associated radio means (radio means for Rx3 not shown) form a third radio chain, and Tx1 and Rx4 with their associated radio means (radio means for Rx4 not shown) form a fourth radio chain.

Similarly, it should be clarified that a data stream, e.g. such as data stream S1 in FIG. 4c and FIG. 6, may e.g. be transmitted by several antennas, e.g. from antennas Tx1 and Tx3 as shown in FIG. 4c. The data stream may then be received by one or several antennas, e.g. Rx1, Rx2, Rx4 as shown in FIG. 4c, each having an associated radio chain means, e.g. in the similar manner as antenna Rx1 and the associated radio chain means RC2. As explained above, Tx1 and Rx1 with their associated radio chain means RC1, RC2 form a first radio chain RC. In the same manner, Tx1 and Rx2 with their associated radio means (radio means for Rx2 not shown) form a second radio chain, whereas Tx1 and Rx4 with their associated radio means (radio means for Rx4 not shown) form a third radio chain. In addition, Tx3 and Rx1 with their associated radio chain means form a fourth radio chain (radio chain means for Tx3 not shown, though being the same as or similar to radio means RC1 for antenna Tx1), whereas Tx3 and Rx2 with their associated radio means (radio means for Tx3 and Rx2 not shown) form a fifth radio chain, and Tx3 and Rx4 with their associated radio means (radio means for Tx3 and Rx4 not shown) form a sixth radio chain.

It should also be added that the signal handling units SH1a, SH2a are preferably arranged to communicate, e.g. via a control channel or similar that is operatively established between the nodes N1a, N2a for the purpose of diagnosing and/or reporting any malfunction and/or for communication parameters, e.g. such as channel quality etc. Diagnosing and/or reporting any malfunction, communication parameters, accomplishing the MIMO-schemes and the multiple antenna schemes are well known features per se (i.e. as such) to a person skilled in the art and their implementations poses no difficulty for the skilled person having the benefit of this disclosure. Thus, the details of diagnosing and/or reporting any malfunction, communication parameters, accomplishing the MIMO-schemes and the multiple antenna schemes to be used herein is not discussed in detail.

In view of the above it can be concluded that the exemplifying antenna arrangement Tx1, Tx2, Tx3, Tx4 may transmit and the antenna arrangement Rx1, Rx2, Rx3, Rx4 may e.g. receive wireless signals in the following manner:

Antenna Tx1 transmits a signal 411a comprising a data stream S1 that is received by all antennas Rx1-Rx4.

Antenna Tx2 transmits a signal 421a comprising a data stream 32 that is received by all antennas Rx1-Rx4.

Antenna Tx3 transmits a signal 431a comprising a data stream S3 that is received by all antennas Rx1-Rx4.

Antenna Tx4 transmits a signal 441a comprising a data stream S4 that is received by all antennas Rx1-Rx4.

A person skilled in the art realises that the exemplifying link arrangement 400a uses a MIMO-scheme.

In case of a symmetric antenna constellation M×N (M=N)—e.g. as the 4×4 constellation in FIG. 4a—the number of data streams of a MIMO-scheme is always less than or equal to the number of antennas. In case of an asymmetric M×N (M≠N) antenna constellation the number of data streams is always less than or equal to the smallest number of antennas. For example, a 4×4 constellation could be used to transmit four (4) or less streams, while a 3×2 system could transmit two (2) or less streams.

MIMO is a well known scheme for increasing the link capacity and/or the link quality for an uncorrelated Rayleigh channel comprising rich scattering by reflections etc. However, rich scattering from reflections is typically not present in fixed links and particularly not in fixed and/or LOS links, which typically display slowly varying and substantially frequency-flat fading channel(s).

However, MIMO can nevertheless be applied for fixed links and even for fixed LOS links or similar, see e.g. the paper “Design of Capacity-Optimal High-Rank Line-of-Sight MIMO Channels” by Frode Bøhagen, Pål Orten and Geir E. Øien, ISBN 82-7368-309-5, ISSN 0806-3036. As described in this paper, it is preferred that the antennas of a first node in a wireless link and/or the antennas of a second node in the wireless link are spaced apart so as to enable various MIMO-scheme, e.g. based on Spatial Multiplexing. The use of high frequencies for the transmission paths of the wireless link arrangements now discussed—e.g. frequencies of 6 GHz or above—makes it practically feasible to separate the antennas of one or both nodes in the link such that the intra antenna distance for antenna of a node at the used frequency is sufficient to enable various MIMO-schemes, e.g. based on Spatial Multiplexing or similar.

Applied to the link 400a in FIG. 4a it is preferred that the antennas Tx1-Tx4 of a node N1a and/or the antennas Rx1-Rx4 of node N2a are separated so as to enable antenna diversity. In other words, it is preferred that the intra antenna distance of the antennas Tx1, Tx2, Tx3, Tx4 of node N1a and/or the intra antenna distance of the antennas Rx1, Rx2, Rx3, Rx4 of node N2a is sufficiently large at the frequency used for the wireless communication of information between said nodes N1a, N2a via said antennas and said transmission paths. This applies mutatis mutandis to link 400b (described later with reference to FIG. 5a-5c) and the intra antenna distance of the antennas Tx1_P, Tx2_Q Tx3_P, Tx4_Q of node N1b and/or the intra antenna distance of the antennas Rx1_P, Rx2_Q, Rx3_P, Rx4_Q of node N2b.

The various MIMO-schemes that can be used in an M×N wireless communication link such as the link 400a (and link 400b as will be elaborated later) may e.g. be Spatial Multiplexing (SM) enabling increased link capacity (Bit/s or Byte/s or similar), or Space-Time Coding (STC) enabling various diversity schemes providing an increased link reliability, or Beam Forming (BF) also providing an increased link reliability (Signal to Noise Ratio (SNR) or Signal to Interferer Ratio (SIR) or similar).

### Spatial Multiplexing (SM)

In case of so-called spatial multiplexing schemes the incoming symbols from an information source are typically precoded and/or distributed to the different transmitting antennas of the transmitting node, i.e. different symbols are typically transmitted by each antenna. A well known transmission architecture operating in this manner is often referred to as “Bell Labs Space-Time Architecture” (BLAST). Naturally, spatial multiplexing can be realized by a variety of other known transmission architectures. The exact manner of realising a suitable spatial multiplexing scheme is less important to the present invention though a brief exemplifying overview is given below.

The received signal vector r in connection with spatial multiplexing (e.g. assuming BLAST or similar) can e.g. be expressed as:

r=\sqrt{X}·Hs+n (1)

wherein X is the common power gain over the spatially multiplexed channel (s), H is the channel matrix, s is the signal vector transmitted by the transmitting antennas and n is additive white Gaussian noise assumed to be present under substantially ideal conditions.

Given the above and assuming that the noise is negligible, it is well known to those skilled in the art that an estimate ŝ of the transmitted signal s can be found by e.g. multiplying r with a matrix C given by the Moore-Penrose pseudoinverse, i.e.:

$$C = \frac{1}{\sqrt{X}} {( {H}^{H} H )}^{- 1} {H}^{H} \qquad ( 2 )$$

wherein H^{H} denotes the Hermitian transpose of H and the detection scheme is assumed to be zero-forcing in that it removes all the interference between the different symbols transmitted.

However, other expressions for the received vector r and for obtaining an estimate ŝ of the transmitted signal s are well known to those skilled in the art.

### Diversity Schemes

Space-Time Coding (STC) in connection with diversity schemes utilizes the spatial dimension by employing at least two (2) antennas sufficiently separated (see the above reference to Bøhagen et. al.) at the transmitting end (e.g. at node N1a in FIG. 4a) and/or at the receiving end (e.g. at node N2a in FIG. 4a).

Different receiving diversity schemes, such as e.g. maximum ratio combining (MRC), selection combining (SC), equal gain combining (EGC), and switched combining are well known to those skilled in the art.

Diversity schemes resulting in transmit diversity introduces redundancy (in time and space) between the signals transmitted with the consequence that the throughput goes down (e.g. compared to using spatial multiplexing) as the diversity order is increased. Such STC schemes can be divided into two main categories; space-time trellis codes (STTCs) and space-time block codes (STBCs). The STTC provides a transmit diversity order equal to the number of transmit antennas, but require a relatively complex receiving algorithm. The STBC have the advantage of allowing simple linear receiver structures due to the design of the codes. The best known STBC is probably the so-called Alamouti code, named after its inventor. This scheme utilizes at least two transmitting antennas, and by coding two information symbols over two time intervals, it achieves full transmit diversity.

### Beam Forming

In addition, various forms of well known beam-forming methods including precoding methods may be used in a MIMO-scheme or similar relevant for embodiments of the present invention. In a single layer (e.g. using one receiving antenna) precoding the same signal comprising the same data stream is transmitted from two or more transmit antennas with appropriate phase and possibly gain weighting such that the signal power is maximised at the receiver input. Here, the signal gain can be perceived as increased from constructive combining. In multi-layer precoding (multiple receiving antennas) multiple data streams are transmitted from the transmit antennas with appropriate weighting per each antenna such that the throughput is maximized at the receiver output. Precoding as such is well known to those skilled in the art. Some background of precoding methods is e.g. discussed in the published patent application WO 2009/097911 A1 invented by Zangi, see e.g. the section labelled “Related Art and other Considerations” particularly paragraphs 0002, 0005 and 0006-0009.

The exemplifying wireless communication link arrangement 400a in FIG. 4a and the MIMO-schemes to be used in connection herewith has now been described in some detail.

The attention is now directed to FIG. 5a schematically illustrating another exemplifying wireless communication link arrangement 400b according to another embodiment of the present invention. The link 400b provides an increased capacity compared to the links 100, 200 and 300 described above. The link 400b may be a Line of Sight (LOS) wireless communication link. In addition or alternatively, the link 400b may be a fixed link, i.e. the emitting and receiving parts of the link 400b are preferably fixed and aligned with respect to each other and can therefore not be operationally moved or transported from one position to another.

The link arrangement 400b comprises a first node N1b and a second node N2b. The nodes N1b, N2b are typically separated by a distance of about 20-60 km, though they may be arranged at a much closer distance (e.g. less than 500 meters).

It is preferred that the link arrangement 400b comprises two 2×2 wireless communication links each being substantially identical to the communication link arrangement 300 discussed with reference to FIG. 3a. Thus it is preferred that node N1b has four (4) antenna arrangements Tx1_P, Tx2_Q, Tx3_P, Tx4_Q arranged to operatively communicate information with node N2b through wireless transmission paths indicated by arrows in FIG. 5a. Similarly it is preferred that node N2b has four antenna arrangements Rx1_P, Rx2_Q, Rx3_P, Rx4_Q arranged to operatively communicate information with node N1b through said wireless transmission paths. It is preferred that the antenna arrangements Tx1_P, Tx2_Q, Tx3_P, Tx4_Q and Rx1_P, Rx2_Q, Rx3_P, Rx4_Q are identical or similar to the antennas Tx1 and Rx1 respectively discussed above with respect to FIG. 1. It is preferred that the transmission paths now discussed are of the same or similar type as transmission path 130a previously discussed with reference to FIG. 1, or as the transmission paths 330a, 330b previously discussed with reference to FIG. 3a. Thus, the wireless transmission paths illustrated in FIG. 4a may e.g. utilize microwaves above 1 GHz, or above 6 GHz or above 30 GHz, or above 50 GHz including various forms of light.

The 4×4 antenna constellation of link 400a in FIG. 5a is merely an example. Other antenna constellations are clearly conceivable. A wireless link arrangement according to embodiments of the present invention may e.g. comprise any number of 2×2 wireless communication links, each being substantially identical or similar to the communication link arrangement 300 previously discussed with reference to FIG. 3a.

The communication between the nodes N1b, N2b in link 400b may be bidirectional, though a unidirectional communication has been illustrated in FIG. 5a by means of arrows (transmission paths) extending from the antennas Tx1_P, Tx2_Q, Tx3_P, Tx4_Q of node N1b to the antennas Rx1_P, Rx2_Q, Rx3_P, Rx4_Q of node N2b.

To accomplish a unidirectional (or bidirectional) communication as indicated above it is preferred that node N1b comprises a first signal handling unit SH1b with hardware and/or software arranged to operatively communicate (i.e. transmit to and possibly receive from) information with node N2b via antennas Tx1_P, Tx2_Q, Tx3_P, Tx4_Q. Similarly it is preferred that node N2b comprises a second signal handling unit SH2b with hardware and/or software arranged to operatively communicate (i.e. receive from and possibly transmit to) information with node N1b via antennas Rx1_P, Rx2_Q, Rx3_P, Rx4_Q. It is also preferred that at least one or even both signal handling units SH1b, SH2b are arranged to operatively detect any malfunction of the communication provided by any of the antennas of node N1b and N2b respectively, and to accomplish the MIMO-schemes and the multiple antenna schemes of the embodiments discussed with reference to link 400b. In addition, the signal handling units SH1b, SH2b are preferably arranged to communicate, e.g. via a control channel or similar established between the nodes N1b, N2b, for diagnosing and/or reporting any malfunction and also for communication parameters, e.g. such as channel quality etc. Diagnosing and/or reporting any malfunction, communication parameters, accomplishing the MIMO-schemes and the multiple antenna schemes to be used for the embodiments of the present invention are well known features per se (i.e. as such) to a person skilled in the art and their implementations poses no difficulty for the skilled person having the benefit of this disclosure. Thus, the details of diagnosing and/or reporting any malfunction, communication parameters, accomplishing the MIMO-schemes and the multiple antenna schemes to be used herein is not discussed in any further detail.

In FIG. 5a the exemplifying antenna arrangement Tx1_P, Tx2_Q, Tx3_P, Tx4_Q transmit and the antenna arrangement Rx1_P, Rx2_Q, Rx3_P, Rx4_Q receive wireless signals 411, 421, 431, 441 in the following manner:

Antenna Tx1_P transmits a signal 411b comprising a data stream S1 that is received by antennas Rx1_P and Rx3_P.

Antenna Tx2_Q transmits a signal 421b comprising a data stream S2 that is received by antennas Rx2_Q and Rx4_Q

Antenna Tx3_P transmits a signal 431b comprising a data stream S3 that is received by antennas Rx1_P and Rx3_P

Antenna Tx4_Q transmits a signal 441b comprising a data stream S4 that is received by antennas Rx2_Q and Rx4_Q

It is preferred that the link arrangement 400b has a first antenna subset 401b formed by the transmit antennas Tx1_P, Tx3_P arranged to operatively transmit a first set of signals 411b, 431b, and a second antenna subset 402b formed by the transmit antennas Tx2_Q, Tx4_Q arranged to operatively transmit a second set of signals 421b, 441b such that the first set of signals are substantially orthogonal with respect to the second set of signals. It is also preferred that the link arrangement 400b has a third antenna subset 403b formed by the receive antennas Rx1_P, Rx3_P arranged to operatively receive the first set of signals, and a fourth antenna subset 404b formed by the receive antennas Rx2_Q, Rx4_Q arranged to operatively receive the second set of signals. The orthogonality may be introduced e.g. by transmitting on orthogonal polarization, i.e. Polarization Multiplexing (PM) or similar.

An advantage of providing two 2×2 wireless links to form a 4×4 wireless link 400b or similar is that a single 2×2 link 300 or similar as described with reference to FIG. 3a can be easily upgraded to a higher capacity by simply adding another 2×2 link of the same or similar kind. This is particularly advantageous when the capacity of backhaul communication provided by a 2×2 link 300 or similar should be increased, since most of the upgrade can be done while the already existing communication continues, and since the existing equipment can be used instead of being dismantle. In addition, the use of one or more additional sets of the same hardware (i.e. adding one more link of the same or similar type) is beneficial from design, production and logistic points of view. This is so even if some additional hardware and/or software may be needed, e.g. in the form of signal handling units SH1b and SH2b in nodes N1b and N2b respectively.

Another advantage of providing two 2×2 wireless communication links to form a 4×4 link 400b or similar is that it enables a Multiple Input and Multiple Output (MIMO) scheme, which is not readily provided by a single link 300. A skilled person having the benefit of this disclosure realises that using a MIMO-scheme in the wireless link 400b or similar will give a substantial increase of the capacity compared to simply combining the capacity of a first 2×2 link 300 or similar and a second 2×2 link 300 or similar.

### Function of Embodiments

As already indicated above, in normal operation it is preferred that the link 400a shown in FIG. 4a communicates information according to a primary MIMO-scheme in which the signal from each antenna of node N1a is received by each antenna of node N2a. The 4×4 antenna constellation of the link 400a allows a maximum of four (4) data streams S1, S2, S3, S4 to be communicated by the primary MIMO-scheme. However, fewer data streams are clearly conceivable.

It is preferred that a malfunction in the primary MIMO-scheme terminating or substantially terminating the communication provided by at least one antenna at one of the nodes N1a or N2a causes the link 400a to continue the communication via the remaining operational antennas according to a secondary reduced MIMO-scheme, e.g. a 4×3 or 3×4 MIMO-scheme which allows a maximum of three (3) data streams to be communicated. The primary MIMO-scheme and the reduced secondary MIMO-schemes may use any type of MIMO-scheme well known to those skilled in the art, e.g. a MIMO-scheme using spatial multiplexing and/or antenna diversity and/or antenna beam-forming or similar. In this respect, the primary and the secondary MIMO-schemes may be of the same type or they may be of different types.

Before we proceed it should be clarified that a malfunction of the communication performed by one or more antennas in link 400a or 400b or similar may be of any sort that terminates or substantially terminates the communication provided by the antenna(s) in question. It may e.g. be a hardware and/or a software failure in the antenna itself and/or in any other microwave component or similar, and/or in the transmitter or receiver and/or transceiver arrangement, or in any other analogue or digital arrangement (e.g. signal processing arrangement and/or power supply arrangement etc) of node N1a, N1b and/or node N2a, N2b.

A first exemplifying malfunction of the link 400a is shown in FIG. 4b illustrating the antennas of link 400a. Here it is assumed that a malfunction in the primary MIMO-scheme causes a failure in the transmitting end of the radio chain comprising antenna Tx1 transmitting signal 411a comprising data stream S1. The link 400a will then continue communicating according to a secondary MIMO-scheme using the remaining operational antennas Tx2, Tx3, Tx4, Rx1, Rx2, Rx3, Rx4. These antennas may be used to communicate signals comprising a reduced number of data streams, e.g. data streams S2, S3, S4 as illustrated in FIG. 4b. It should be clarified that the data previously communicated via stream S1 is preferably transported via the remaining streams S2. S3 and/or S4 giving a reduced rate in total.

Another exemplifying malfunction of the link 400a is shown in FIG. 4c illustrating the same antennas as in FIG. 4b. Here it is assumed that a malfunction in the primary MIMO-scheme causes a failure in the receiving end of the radio chain comprising antenna Rx3 receiving signals 411a, 421a, 431a and 441a comprising a data streams S1, S2, S3 and S4 respectively. The link 400a will then continue communicating according to a secondary MIMO-scheme using the remaining operational antennas Tx1, Tx2, Tx3, Tx4, Rx1, Rx2, Rx4. These antennas can be used to communicate signals comprising a reduced number of data streams, e.g. data streams S1, S2, S3 as illustrated in FIG. 4c. It should be clarified that the data previously communicated via stream S4 is preferably transported via the remaining streams S1, S2 and/or S3 giving a reduced rate in total.

Thus, in case of a malfunction in the communication provided by an antenna in the exemplifying primary 4×4 MIMO-scheme of link 400a communicating four (4) data streams S1-S4 the communication may nevertheless continue via a reduced second number of data streams according to a secondary 3×4 or 4×3 MIMO-scheme, e.g. communicating three (3) data streams or less, using the remaining operational antennas.

Generally, if the communication provided by an antenna of link 400a in a primary M×N MIMO-scheme malfunctions then the link 400a may be arranged to operatively continue the communication by a secondary (M−1)×N or M×(N−1) MIMO-scheme using the communication provided by the remaining operational antennas. A first number of m data streams communicated by the primary MIMO-scheme will then be reduced to a second number of m−1 data streams or an even lower number of data streams communicated by the secondary MIMO-scheme. If the communication provided by n antennas malfunction in the primary MIMO-scheme communicating m data streams, then the communication may be continued by a secondary MIMO-scheme communicating m-n data streams or less.

The attention is now directed to link 400b shown in FIG. 5a forming another embodiment of the present invention. As already indicated above, it is preferred that the link 400b comprises a first antenna subset 401b formed by antennas Tx1_P and Tx3_P, and a second antenna subset 402b formed by antennas Tx2_Q and Tx4_Q, and a third antenna subset 403b formed by the antennas Rx1_P and Rx3_P, and a fourth antenna subset 404b formed by the antennas Rx2_Q and Rx4_Q.

Before we proceed it should be added that the previously discussed link 400a in FIG. 4a can also be considered to comprise a first antenna subset 401a (Tx1, Tx3), a second antenna subset 402a (Tx2, Tx4), a third antenna subset 403a (Rx1, Rx3) and a fourth antenna subset 404a (Rx2, Rx4). The first, second, third and fourth antenna subset 401a, 402a, 403a, and 404a respectively of link 400a can be said to correspond to the first antenna subset 401b, second antenna subset 402b, third antenna subset 403b and fourth antenna subset 404b of link 400b.

With respect to link 400b shown in FIG. 5a it is preferred that a primary MIMO-scheme is formed by a first MIMO-scheme and a second MIMO-scheme, i.e. the primary MIMO-scheme is formed by two MIMO-schemes. Here, the first MIMO-scheme is formed by the first antenna subset 401b (Tx1_P, Tx3_P) communicating with the third antenna subset 403b (Rx1_P, Rx3_P), and the second 2×2 MIMO-scheme is formed by the second antenna subset 402b (Tx2_Q, Tx4_Q) communicating with the fourth antenna subset 404b (Rx2_Q, Rx4_Q).

In normal operations it is preferred that the first MIMO-scheme communicates information such that the signal from each antenna of the first antenna subset 401b (Tx1_P, Tx3_P) is received by each antenna of the third antenna subset 403b (Rx1_P, Rx3_P). Similarly it is preferred that the second MIMO-scheme communicates information such that the signal from each antenna of the second antenna subset 402b (Tx2_Q, Tx4_Q) is received by each antenna of the fourth antenna subset 404b (Rx2_Q, Rx4_Q). The first MIMO-scheme and the second MIMO-scheme may be of any type well known to those skilled in the art, e.g. a MIMO-scheme using spatial multiplexing and/or antenna diversity and/or antenna beam-forming or similar. In this respect, the first MIMO-scheme and the second MIMO-scheme may be of the same type, or they may be of different types. The 4×4 antenna constellation of link 400b allows the primary MIMO-scheme to communicate a maximum of four (4) data streams S1, S2, S3, S4. However, a communication of fewer data streams is clearly conceivable, though typically less efficient.

Before we proceed it should be mentioned that the first MIMO-scheme may communicate by a first set of signals 411b, 431b whereas the second MIMO-scheme may communicate by a second set of signals 421b, 441b such that the first set of signals is substantially orthogonal with respect to the second set of signals. The orthogonality is preferably provided by means of Polarisation Multiplexing (PM) or similar according to which the first antenna subset 401b (Tx1_P, Tx3_P) and the third antenna subset 403b (Rx1_P, Rx3_P) are arranged to communicate with a first polarization, whereas the second antenna subset 402b (Tx2_Q, Tx4_Q) and the fourth antenna subset 404b (Rx2_Q, Rx4_Q) are arranged to communicate with a second polarization being substantially orthogonal with respect to the first polarization.

It should be emphasised that any manner of communicating by means of signals that are orthogonal at the same frequency at the same time—including PM—can be applied to achieve orthogonality with respect to embodiments of the present invention.

It is preferred that a malfunction in the primary MIMO-scheme terminating or substantially terminating the communication performed by one antenna at node N1b or N2b causes the link 400b to continue the communication via the remaining operational antennas according to a reduced secondary MIMO-scheme, e.g. a 4×3 or 3×4 MIMO-scheme which allows a maximum of three (3) data streams to be communicated.

The primary MIMO-scheme and the reduced secondary MIMO-schemes may use any type of MIMO-scheme well known to those skilled in the art, e.g. a MIMO-scheme using spatial multiplexing and/or antenna diversity and/or antenna beam-forming or similar. In this respect, the primary and the secondary MIMO-schemes may be of the same type or they may be of different types.

A first exemplifying malfunction of the link 400b is shown in FIG. 5b illustrating the antennas of link 400b. Here it is assumed that a malfunction in the primary MIMO-scheme causes a failure in the transmitting end of the radio chain comprising antenna Tx2_Q of the second antenna subset 402b transmitting signal 421b comprising data stream S2. The link 400b will then continue communicating according to a secondary MIMO-scheme using the operational antennas of the first antenna subset (Tx1_P, Tx3_P) and the third antenna subset 403b (Rx1_P, Rx3_P) of the first MIMO-scheme, and the remaining operational antennas in the second antenna subset 402b (Tx4_Q) and the fourth antenna subset (Rx2_Q, Rx4_Q] of the second MIMO-scheme. These antennas may be used to communicate signals comprising a reduced number of data streams, e.g. data stream S1 from Tx1_P to Rx1_P and Rx3_P and stream S1 or S3 from Tx3_P to Rx1_P and Rx3_P and stream S4 from Tx4_Q to Rx2_Q and Rx4_Q as illustrated in FIG. 5b.

The first antenna subset 401b (Tx1_P, Tx3_P) and the third antenna subset 403b (Rx1_P, Rx3_P) may now form a new third MIMO-scheme, whereas the second antenna subset (Tx4_Q) and the fourth antenna subset 404b (Rx2_Q, Rx4_Q) now form a Single Input Multiple Output scheme (SIMO-scheme). The new MIMO-scheme and the SIMO-scheme together form a secondary MIMO-scheme, justifiably denoted so since there is at least one MIMO-scheme involved.

Here, the SIMO-scheme communicating a single stream S4 may e.g. be a multiple antenna scheme that utilizes a receiving antenna diversity scheme to obtain high communication reliability, e.g. Maximum Ratio Combining (MRC) providing both full receiving antenna diversity and array gain. The same applies mutatis mutandis for link 400a, e.g. in case a SIMO-scheme or similar is used, e.g. used as a part of an overall MIMO-scheme.

Moreover, if the new third MIMO-scheme only transmits a single stream S1 from the first antenna subset 401b (Tx1_P, Tx3_P) then beam-forming may be utilized to increase the power at the receiving antennas of the third antenna subset (Rx1_P, Rx3_P) giving a higher communication reliability, and/or the capacity can be increased, at least compared to a SISO scheme or similar, due to the increased SNR. The same applies mutatis mutandis for link 400a, e.g. in case a single data stream is transmitted from an antenna subset in link 400a. If the new third MIMO-scheme communicates two streams, e.g. S1 and S3, from the first antenna subset 401b (Tx1_P, Tx3_P) then a spatial multiplexing scheme may be utilized to obtain a high communication capacity. The same applies mutatis mutandis for link 400a, e.g. in case a two data streams are transmitted from an antenna subset in link 400a.

Another exemplifying malfunction of the link 400b is shown in FIG. 5c illustrating the same antennas as in FIG. 5b. Here it is assumed that a malfunction in the primary MIMO-scheme causes a failure in the receiving end of the radio chain comprising antenna Rx3_P receiving signals 411b and 431b comprising a data streams S1 and S3 respectively. The link 400b will then continue communicating according to a secondary MIMO-scheme using the remaining operational antennas of the first antenna subset 401b (Tx1_P, Tx3_P) and the third antenna subset 403b (Rx1_P) of the first MIMO-scheme, and the operational antennas in the second antenna subset 402b (Tx2_Q, Tx4_Q) and the fourth antenna subset (Rx2_Q, Rx4_Q] of the second MIMO-scheme.

These antennas may be used for communicating signals comprising a reduced number of data streams, e.g. data stream S1 from Tx1_P to Rx1_P and stream S2 from Tx2_Q to Rx2_Q and Rx4_Q and stream S1 from Tx3_P to Rx1_P and stream S3 or S4 from Tx4_Q to Rx2_Q and Rx4_Q as illustrated in FIG. 5c.

The second antenna subset 402b (Tx2_Q, Tx4_Q) and the fourth antenna subset 404b (Rx2_Q, Rx4_Q) may now form a new third MIMO-scheme, whereas the first antenna subset (Tx1_P) and the third antenna subset 403b (Rx1) now form a Multiple Input Single Output scheme (MISO-scheme). The new third MIMO-scheme and the MISO-scheme together form a secondary MIMO-scheme, justifiably denoted so since there is at least one MIMO-scheme involved.

Here, the MISO-scheme communicating a single stream S1 may e.g. form a multiple antenna scheme that utilizes a transmit antenna diversity scheme to obtain a high communication reliability (e.g. by means of an Alamouti code), or a beam-forming scheme e.g. coherently transmitting stream S1 to increase the power at the receiving antenna Rx1_P. The same applies mutatis mutandis for link 400a, e.g. in case a MISO-scheme or similar is used in link 400a.

Similarly, if the new third MIMO-scheme only transmits a single stream S2 from the first antenna subset 401b (Tx1_P, Tx3_P) then beam-forming may be utilized to increase the power at the receiving antennas of the third antenna subset (Rx1_P, Rx3_P) giving a higher communication reliability. If the new MIMO-scheme communicates two streams, e.g. S2 and S3, from the first antenna subset 401b (Tx1_P, Tx3_P) then a spatial multiplexing scheme may be utilized to obtain a high communication capacity.

The observant reader realizes that a malfunction in the communication provided by an antenna in a primary M×N MIMO-scheme of link 400b then the link 400b may be arranged to operatively continue the communication by a secondary (M−1)×N or M×(N−1) MIMO-scheme. A first number of m data streams communicated by the primary MIMO-scheme may then be reduced to a second number of m−1 data streams or less being communicated by the secondary MIMO-scheme. If n antennas malfunction in the primary MIMO-scheme communicating m data streams the communication may be continued by a secondary MIMO-scheme communicating m-n data streams or less, at least if n antennas malfunctions at the same node N1 or N2.

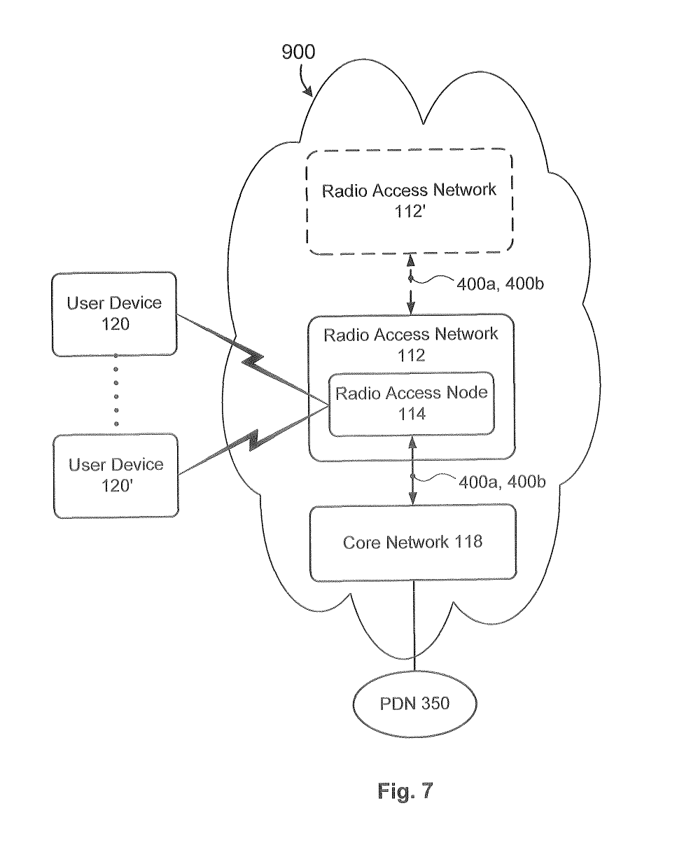

FIG. 7 is a schematic illustration of a wireless communication link 400a or 400b as described above being used for backhaul communication in a wireless communication network 900 according to an embodiment of the present invention. Here, the wireless communication link 400a, 400b is used for communicating data between a core network 118 or similar (e.g. such as the Evolved Packet Core (EPC) in the Long Term Evolution (LTE) or similar) and one or several radio access node arrangements 114 or similar node arrangements (e.g. one or several base stations or similar and/or a Base Station Controller (BSC) or a Radio Network Controller (RNC) or similar) in a radio access network 112 (e.g. a Universal Mobile Telecommunication System Radio Access Network, UTRAN or an E-UTRAN or similar). As can be seen in FIG. 7, each radio access node 114 is in turn configured to operatively communicate with one or several user devices 120 (e.g. such as a portable communication device such as cell phone or a laptop computer or similar provided with the appropriate communication ability). Similarly, the core network 118 may in turn be configured to operatively act as an interface between the radio access network 112 and various external data networks or similar, e.g. such as a Packet Data Network (PDN) 350 or similar. The Internet is a well known example of a PDN. In addition, a wireless communication link 400a or 400b may additionally or alternatively be used in backhaul communication for communicating data between one or several node arrangements in a radio access network as indicated by a dashed line in FIG. 7, e.g. between the radio access node arrangement 112 and a similar radio access node arrangement 112′. However, the use now discussed does not preclude that the wireless communication link 400a or 400b may be used for communicating between node arrangements within a radio access network or similar or within a core network or similar.

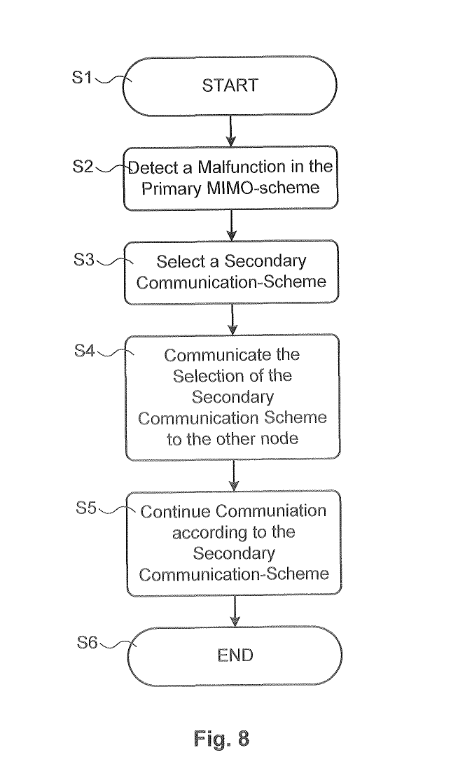

The steps of an exemplifying operation illustrated by the flowchart in FIG. 8 will now be discussed in more detail below.

Before we proceed it should be clarified that the exemplifying steps may e.g. be performed by the first node N1a, N1b or the second node N2a, N2b. For example, the receiving node N2a. N2b may perform the steps while communicating the necessary instructions and/or findings or similar with the transmitting node N2a, N2b. Conversely, the transmitting node N2a, N2b may perform the steps while communicating the necessary instructions and/or findings or similar with the receiving node N2a. N2b.

In a first step St1 it is preferred that the link 400a, 400b is activated so as to communicate according to a first MIMO-scheme as described above.

In a second step St2 it is preferred that a detection of a malfunction for at least one radio chain of the primary MIMO-scheme.

The detection of a malfunction may e.g. be accomplished by a signal handling unit SH1a, SH2a measuring the error rate (e.g. Bit Error Rate or Block Error Rate or similar) for a data stream S1, S2, S3 or S4 comprised by a signal 411b, 421b, 431b or 431b respectively. If the error rate is too high or if a signal S1, S2, S3 or S4 is not received at all this indicates a malfunction in the radio chain communicating that signal.

Alternatively the signals 411b, 421b, 431b, 431b may e.g. comprise a known pilot signal or similar sent in a predetermined order or sequence (e.g. at short intervals). If one signal 411b, 421b, 431b or 431b comprises a pilot signal it will typically be received by all antennas Rx1, Rx2, Rx3, Rx4 at each transmission. However, if the pilot signal is not received at all or e.g. received with an error rate that is too high this indicates a malfunction in the radio chain communicating that signal, typically at the transmitting end. If the pilot signal is not received via one of the receiving antennas Rx1, Rx2, Rx3, Rx4 this indicates a malfunction at the receiving end of the radio chain to which this antenna belongs. The above is merely examples and a person skilled in the art having the benefit of this disclosure realises that a malfunction in a radio chain communicating a wireless signal 411b, 421b, 431b or 431b comprising a data stream S1, S2, S3 or S4 respectively can be detected in may other ways. How a malfunction is detected is not essential provided that detection occurs.

In a third step St3 it is preferred that a secondary communication scheme is selected, e.g. a secondary MIMO-scheme. The selection may e.g. be based on a table or similar comprising the settings or similar for a secondary MIMO-scheme or similar to be used when a certain malfunction is detected, e.g. which secondary MIMO-scheme to use when a certain radio chain malfunctions in a certain manner (e.g. malfunctions fully or partly). A person skilled in the art having the benefit of this disclosure realises that there are many other ways of selecting an appropriate secondary MIMO-scheme.

In a fourth step S4 it is preferred that the selection of the secondary MIMO-scheme is communicated from the first node to the second node of the communication link 400a, 400b, such that the second node knows which MIMO-scheme to be use for the continued communication with the first node. Here, it is assumed that the exemplifying method now described is performed in the first node and that the first node took the decision of which secondary MIMO-scheme to be used for the continued communication.

In a fifth step S5 it is assumed that the communication between the first node and the second node of the communication link 400a, 400b continues according to the secondary MIMO-scheme.

The method is preferably terminated in a sixth step S6

It should be added that a further embodiment of the link arrangement according to the second embodiment mentioned above in the Summary may be configured to operatively:
a) provide the primary MIMO scheme such that:
   a first MIMO scheme is provided by the radio chains comprising a first antenna subset 401a; 401b of the first node N1a; N1b and a third antenna subset 403a; 403b of the second node N2a; N2b communicating a first number of data streams S1, S3, and
   a second MIMO scheme is provided by the radio chains comprising a second antenna subset 402a; 402b of the first node N1a; N1b and fourth antenna subset 404a; 404b of the second node N2a; N2b communicating a second number of data streams S2, S4, and
b) select a secondary communication scheme by selecting a new communication scheme using a reduced number of data streams S1 communicated by the other radio chains of the malfunction first MIMO scheme or the other radio chains of the malfunctioning second MIMO scheme, and select a third MIMO scheme to be used the radio chains of the functioning first MIMO scheme or the functioning second MIMO scheme.

Here, the third MIMO scheme may be the same as the first MIMO scheme or the second MIMO scheme. Similarly, the first number of data streams S1, S3 may be communicated in a substantially orthogonal manner with respect to the second number of data streams S2, S4.

The link arrangement in the further embodiment may comprise at least two sub link arrangements 300, each comprising:
a first wireless link 100a having a first transmission antenna Tx1_P and a first receiving antenna Rx1_P arranged to communicate the first data stream S1, S3, and
a second wireless link 100a′ having a second transmitting antenna Tx2_Q and a second receiving antenna Rx2_Q arranged to communicate the second data stream S2, S4.

The present invention has now been described with reference to exemplifying embodiments. However, the invention is not limited to the embodiments described herein. On the contrary, the full extent of the invention is only determined by the scope of the appended claims.

1. A method for a controlled degradation in a wireless communication link arrangement comprising a first node with a plurality of transmitting antenna arrangements and a second node with a plurality of receiving antenna arrangements forming a number of radio chains (RC) each arranged to operatively communicate a signal comprising a data stream so as to form a primary MIMO-scheme,
which method performed in at least one node comprises the steps of:
detecting a malfunction for at least one radio chain (RC) of the primary MIMO-scheme,
selecting a communication scheme using a reduced number of data streams communicated by the other radio chains of the link arrangement,
communicating the selection of the communication scheme to the other node, and
continuing the communication according to a communication scheme.

2. The method according to claim 1,
wherein:
the communication scheme is at least partly provided according to at least one of: a spatial multiplexing scheme for obtaining a high communication capacity; or an antenna diversity scheme for obtaining a high communication reliability or a high communication capacity; or a beam-forming scheme for increasing the power of signals transmitted by the communication scheme.

3. The method according to claim 2,
wherein:
the spatial multiplexing scheme is a secondary MIMO-scheme, whereas the antenna diversity scheme and the beam-forming scheme is one of: a secondary MIMO-scheme, a MISO-scheme or a SIMO-scheme.

4. A method according to claim 1,
wherein:
the wireless communication link arrangement is a Point-to-Point link or Point-to-Multipont link being arranged as one or more of a fixed link and a Line of Sight link.

5. A method according to claim 1,
wherein:
the wireless communication link arrangement provides backhaul communication in a wireless mobile communication system.

6. A wireless communication link arrangement comprising a first node with a plurality of transmitting antenna arrangements and a second node with a plurality of receiving antenna arrangements that form a number of radio chains (RC) each arranged to operatively communicate a signal comprising a data stream so as to form a primary MIMO-scheme, wherein at least one of the nodes is arranged to control the degradation of the link by being configured to operatively:
detect a malfunction for at least one radio chain (RC) of the primary MIMO-scheme,
select a communication scheme using a reduced number of data streams communicated by the other radio chains of the link arrangement,
communicate the selection of the communication scheme to the other node, and
continue the communication according to a communication scheme.

7. A link arrangement according to claim 6,
configured to operatively provide the communication scheme at least partly according to at least one of: a spatial multiplexing scheme for obtaining a high communication capacity; or an antenna diversity scheme for obtaining a high communication reliability a high communication capacity; or a beam-forming scheme for increasing the power of signals transmitted by the communication scheme.

8. A link arrangement according to claim 7,
wherein the spatial multiplexing scheme is a secondary MIMO-scheme, whereas the antenna diversity scheme and the beam-forming scheme is one of: a secondary MIMO-scheme, a MISO-scheme or a SIMO-scheme.

9. A link arrangement according to claim 6, wherein the wireless communication link arrangement is a Point-to-Point link or Point-to-Multipont link being arranged as one or more of a fixed link and a Line of Sight link.

10. A link arrangement according to claim 6, wherein: the wireless communication link arrangement is arranged to operatively provide backhaul communication in a wireless mobile communication system.
